(19) United States
(12) Patent Application Publication
(10) Pub. No.: US 2024/0329627 A1
(43) Pub. Date: Oct. 3, 2024

(54) FACTOR ANALYSIS SUPPORT SYSTEM FOR TIME-SERIES DATA AND FACTOR ANALYSIS SUPPORT METHOD FOR TIME-SERIES DATA

(71) Applicant: Hitachi, Ltd., Tokyo (JP)

(72) Inventors: Naoaki YOKOI, Tokyo (JP); Masashi EGI, Tokyo (JP)

(73) Assignee: Hitachi, Ltd., Tokyo (JP)

(21) Appl. No.: 18/468,247

(22) Filed: Sep. 15, 2023

(30) Foreign Application Priority Data
Mar. 30, 2023 (JP) 2023-056372

(51) Int. Cl. G05B 23/02

(52) U.S. Cl. CPC G05B 23/0221; G05B 23/0275; G05B 23/0286

(57) ABSTRACT

By using a time-series causal model stored in a time-series causal model storage unit and time-series data of an analysis target, a contribution degree restoration rate is calculated by evaluating how much a contribution degree of each time-series variable at each time is required to be restored to the contribution degree of another time-series variable at another time. Further, the contribution degree of each time-series variable at each time is restored, based on the calculated contribution degree restoration rate, to the contribution degree of the other time-series variable at the other time, and the transition of the contribution degree by a root factor with respect to an objective variable is calculated. Additionally, the contribution degree by the root factor with respect to the calculated objective variable is output.

### BACKGROUND

### Technical Field

The present invention relates to a factor analysis support system for time-series data and a factor analysis support method for time-series data.

### Related Art

In quality improvement in the manufacturing industry, it is essential to analyze a factor for a product defect from time-series data such as various sensor values in the manufacturing process, and to examine and implement a specific countermeasure based on the analysis result. It is known to use artificial intelligence (AI) at the time of performing factor analysis from the time-series data such as various sensor values in the manufacturing process. That is, it is known that a relationship between manufacturing data and a defect degree of a product is learned by AI, and a factor contributing to an increase in the defect degree is mechanically extracted by an explainable AI (XAI) technology. Here, if an input to AI is a time variable (factor×time), it is possible to quantify and visualize time-series transition of the influence on quality by each time and each factor.

Patent Literature 1 describes a technology capable of estimating a non-linear causal relationship between dimensions using time-series multivariate data obtained from a system. That is, Patent Literature 1 describes a technology of learning a non-linear regression model that predicts data at a certain time from data at a past time using data of an input time-series multidimensional numerical vector, and calculating the strength of cause and effect of each dimension in the data of the time-series multidimensional numerical vector using the non-linear regression model.

### CITATION LIST

### Patent Literature

Patent Literature 1: JP 2019-144779 A

### SUMMARY

As described in Patent Literature 1, when a certain state occurs, it is performed to estimate the strength of cause and effect of the state in the related art. As a result, for example, when a defect occurs at the time of manufacturing, it is possible to determine which time-series data such as various sensor values in a manufacturing process is linked to the defect. However, in an analysis method in the related art, it is only possible to determine what kind of data is linked to a defect in time-series data such as a temperature and a pressure of each unit, and as such it may not be possible to determine how to perform a control operation to prevent the defect.

For example, it is assumed that, when a temperature at a point A, a temperature at a point B, a pressure at a point C, and the like are measured as time-series data by a temperature sensor and a pressure sensor, it is determined that information on the temperature at the point B causes deterioration in manufacturing quality in the analysis method in the related art. At this time, when the temperature at the point B is a temperature that cannot be directly controlled on the manufacturing line, it is not possible to determine what kind of countermeasure is necessary to reduce the temperature at the point B from the analysis result. Therefore, as a result, there is a problem in that a specific countermeasure cannot be taken against deterioration in manufacturing quality.

In addition, even in a case where the temperature at the point B described above can be directly controlled, there is also a problem in that a countermeasure cannot be actually implemented at a timing when the influence of quality deterioration increases without estimating, in advance, a type of control operation and how much quality is improved by performing the above-mentioned type of control operation.

In consideration of the above-described circumstances, an object of the present invention is to provide a factor analysis support system for time-series data and a factor analysis support method for time-series data capable of clarifying a countermeasure against an analyzed and cause providing the clarified countermeasure.

In order to solve the above-described problems, for example, the configuration described in the scope of the claims is adopted.

The present application includes a plurality of means for solving the above-described problems. As one of examples of the plurality of means, a factor analysis support system for time-series data of the present invention is a factor analysis support system for time-series data that analyzes transition of a contribution degree to an objective variable by a time-series variable, the factor analysis support system including: a time-series causal model storage unit configured to store a time-series causal model for each time-series variable; a contribution degree calculation unit configured to calculate, using the time-series causal model stored in the time-series causal model storage unit and time-series data of an analysis target, a contribution degree restoration rate obtained by evaluating how much the contribution degree of each time-series variable at each time is required to be restored to the contribution degree of another time-series variable at another time; a contribution degree restoration unit configured to restore, based on the contribution degree restoration rate calculated by the contribution degree calculation unit, the contribution degree of each time-series variable at each time to the contribution degree of the other time-series variable at the other time, and to calculate the transition of the contribution degree by a root factor with respect to the objective variable; and an output unit configured to output the contribution degree by the root factor with respect to the objective variable, the contribution degree being calculated by the contribution degree restoration unit.

According to the present invention, a restoration rate of a contribution degree to a root factor is calculated and output, and the factor is narrowed down which is easy to be examined for a user to prepare a countermeasure, thereby making it possible to present a process causing deterioration in quality or the like to the user.

Problems, configurations, and effects other than those described above will be clarified by the following description of embodiments.

### BRIEF DESCRIPTION OF DRAWINGS

FIG. 1 is a configuration diagram illustrating an example of a factor analysis support system according to a first embodiment of the present invention;

FIG. 2 is a configuration diagram illustrating a hardware example of the factor analysis support system according to the first embodiment of the present invention;

FIG. 3 is a diagram illustrating an example of an actual time-series data table by the factor analysis support system according to the first embodiment of the present invention;

FIG. 4 is a diagram illustrating an example of an actual non-time-series data table by the factor analysis support system according to the first embodiment of the present invention;

FIG. 5 is a diagram illustrating an example of a target time-series data table by the factor analysis support system according to the first embodiment of the present invention;

FIG. 6 is a diagram illustrating an example of a target non-time-series data table by the factor analysis support system according to the first embodiment of the present invention;

FIG. 7 is a configuration diagram illustrating an example of a predictor generation unit by the factor analysis support system according to the first embodiment of the present invention;

FIG. 8 is a diagram illustrating an example of actual time variable data by the factor analysis support system according to the first embodiment of the present invention;

FIG. 9 is a flowchart illustrating a processing example of a time variable generation unit by the factor analysis support system according to the first embodiment of the present invention;

FIG. 10 is a flowchart illustrating a processing example of the predictor generation unit by the factor analysis support system according to the first embodiment of the present invention;

FIG. 11 is a diagram illustrating a generation example of a time-series causal model by the factor analysis support system according to the first embodiment of the present invention;

FIG. 12 is a diagram illustrating an example of lag variable data by the factor analysis support system according to the first embodiment of the present invention;

FIG. 13 is a diagram illustrating an example of time-series objective variable group data by the factor analysis support system according to the first embodiment of the present invention;

FIG. 14 is a flowchart illustrating a processing example of a lag variable generation unit by the factor analysis support system according to the first embodiment of the present invention;

FIG. 15 is a configuration diagram illustrating an example of a contribution degree calculation unit by the factor analysis support system according to the first embodiment of the present invention;

FIG. 16 is a diagram illustrating an example of target time variable data by the factor analysis support system according to the first embodiment of the present invention;

FIG. 17 is a diagram illustrating an example of a contribution degree for each time variable by the factor analysis support system according to the first embodiment of the present invention;

FIG. 18 is a diagram illustrating an example of a contribution degree for each non-time-series variable by the factor analysis support system according to the first embodiment of the present invention;

FIG. 19 is a flowchart illustrating a processing example of the contribution degree calculation unit by the factor analysis support system according to the first embodiment of the present invention;

FIG. 20 is a configuration diagram illustrating a restoration processing example of the contribution degree for each time variable by the factor analysis support system according to the first embodiment of the present invention;

FIG. 21 is a diagram illustrating an example of target lag variable data by the factor analysis support system according to the first embodiment of the present invention;

FIG. 22 is a diagram illustrating an example of contribution degree restoration rate data by the factor analysis support system according to the first embodiment of the present invention;

FIG. 23 is a flowchart illustrating the restoration processing example of the contribution degree for each time variable by the factor analysis support system according to the first embodiment of the present invention;

FIG. 24 is a flowchart illustrating a processing example of a restoration rate calculation unit by the factor analysis support system according to the first embodiment of the present invention;

FIG. 25 is a flowchart illustrating a processing example of a contribution degree restoration unit by the factor analysis support system according to the first embodiment of the present invention;

FIG. 26 is a diagram illustrating an example of a factor analysis screen in a result output unit by the factor analysis support system according to the first embodiment of the present invention;

FIG. 27 is a diagram illustrating an example of a countermeasure examination screen by a factor analysis support system according to a second embodiment of the present invention;

FIG. 28 is a configuration diagram illustrating an example of preliminary effect verification processing including countermeasure examination by the factor analysis support system according to the second embodiment of the present invention;

FIG. 29 is a diagram illustrating an example of change content data by the factor analysis support system according to the second embodiment of the present invention;

FIG. 30 is a flowchart illustrating a processing example of a change content extraction unit by the factor analysis support system according to the second embodiment of the present invention; and

FIG. 31 is a flowchart illustrating a processing example of a change data generation unit by the factor analysis support system according to the second embodiment of the present invention.

### DETAILED DESCRIPTION

### First Embodiment

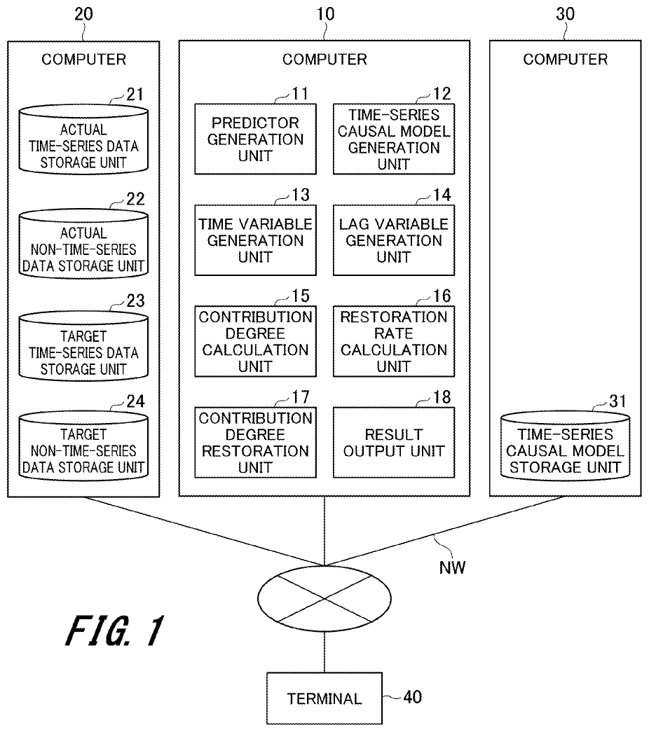

Hereinafter, a factor analysis support system for time-series data and a factor analysis support method for time-series data according to a first embodiment of the present invention will be described with reference to FIGS. 1 to 26.

### [Overall Configuration of Factor Analysis Support System]

FIG. 1 illustrates an overall configuration of the factor analysis support system according to the present embodiment.

As illustrated in FIG. 1, the factor analysis support system includes a plurality of computers 10, 20, and 30, and a terminal 40 connected to each of the computers 10 to 30 via a network NW. However, the configuration including the plurality of computers 10 to 30 and the terminal 40 is an example, and for example, the computers 10 to 30 may be configured as one computer, or the terminal 40 may not be configured separately from the computer.

The computer 10 includes a predictor generation unit 11, a time-series causal model generation unit 12, a time variable generation unit 13, a lag variable generation unit 14, a contribution degree calculation unit 15, a restoration rate calculation unit 16, a contribution degree restoration unit 17, and a result output unit 18.

The computer 20 includes an actual time-series data storage unit 21, an actual non-time-series data storage unit 22, a target time-series data storage unit 23, and a target non-time-series data storage unit 24.

The computer 30 includes a time-series causal model storage unit 31.

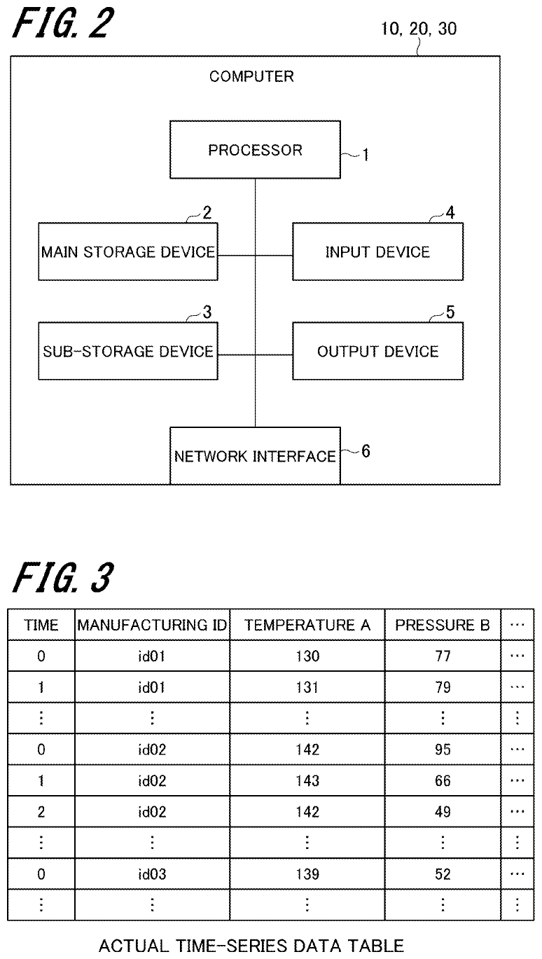

FIG. 2 illustrates a hardware configuration example of each of the computers 10, 20, and 30. Here, the computer 10 will be described as an example, but the other computers 20 and 30 have similar configurations. Further, the terminal 40 basically has the same configuration as the computer 10.

The computer 10 includes a processor 1, a main storage device 2, a sub-storage device 3, an input device 4, an output device 5, and a network interface 6.

The processor 1 controls execution in the main storage device 2 of a program stored in the main storage device 2 or the sub-storage device 3. Then, the processor 1 executes the program to configure each processing unit and storage unit illustrated in FIG. 1 in the main storage device 2 or the sub-storage device 3.

The input device 4 is formed of an input device such as a keyboard or a mouse, and receives an input operation from an operator. The output device 5 is formed of a display device, a voice output device, and the like, displays a processing result and the like, and conveys the processing result by voice.

The network interface 6 transmits and receives data to and from the other computers 20 and 30 and the terminal 40 via the network NW.

### [Example of Each Piece of Data]

Next, an example of data handled by the system of the present example will be described.

FIG. 3 illustrates actual time-series data of temperature A, pressure B, . . . , which are stored in the actual time-series data storage unit 21 and measured by a sensor installed in a manufacturing line handled in the present embodiment.

As illustrated in FIG. 3, the actual time-series data is stored, for each manufacturing ID, in the actual time-series data storage unit 21 in chronological order with actual values of the temperature A, the pressure B, . . . at time 0, actual values of the temperature A, the pressure B, . . . at time 1, and actual values of the temperature A, the pressure B, . . . at time 2.

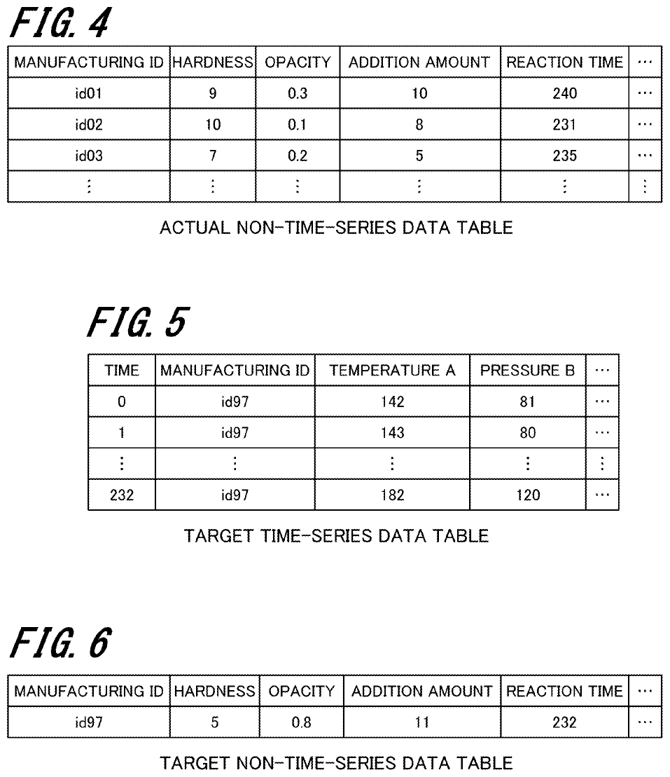

FIG. 4 illustrates actual non-time-series data stored in the actual non-time-series data storage unit 22 and measured by a sensor installed in the manufacturing line handled in the present embodiment or measured in the inspection process of a product. Here, hardness, opacity, an addition amount of a substance used in the manufacturing reaction time required for the manufacturing process, and the like of a product manufactured in the manufacturing line are stored.

As illustrated in FIG. 4, in the actual non-time-series data, the hardness, the opacity, the addition amount, the reaction time, and the like are stored as one record for each manufacturing ID.

FIG. 5 illustrates time-series data of temperature A, pressure B, . . . configured to serve as factor analysis targets of a defective product and stored in the target time-series data storage unit 23.

In FIG. 5, target time-series data indicates the actual values of the temperature A, the pressure B, . . . at time 0 of a manufacturing ID of an analysis target.

FIG. 6 illustrates non-time-series data such as hardness, opacity, an addition amount, and reaction time serving as factor analysis targets of a defective product, which are stored in the target non-time-series data storage unit 24.

In FIG. 6, the target non-time-series data indicates the hardness, the opacity, the addition amount, the reaction time, and the like of a manufacturing ID of an analysis target.

Here, a polymer product is used as a product, and when the product is cloudy, the product is regarded as a defective product. Further, the “opacity” is adopted as an index of a defect degree.

### [Processing of Predictor Generation Unit]

Next, descriptions will be sequentially given as to processing of performing factor analysis support for the time-series data in the configuration of FIG. 1 by using such time-series data and non-time-series data.

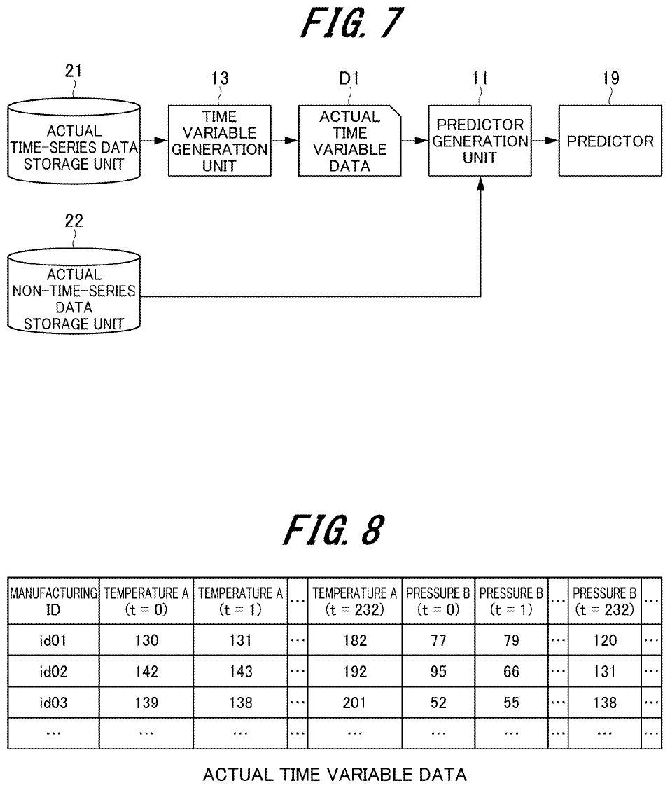

FIG. 7 illustrates a configuration of the predictor generation unit 11.

The predictor generation unit 11 uses the actual time-series data (in FIG. 3) stored in the actual time-series data storage unit 21 and the actual non-time-series data (in FIG. 4) stored in the actual non-time-series data storage unit 22, thereby performing prediction processing of learning a relationship between past actual data (the time-series data and the non-time-series data) and the defect degree (opacity). As the learning here, for example, learning by a machine learning model is applied, but learning by a simple regression model may be used.

First, the time variable generation unit 13 generates actual time variable data D1 from the actual time-series data stored in the actual time-series data storage unit 21 in order to generate a predictor.

FIG. 8 illustrates an example of the actual time variable data D1 generated by the time variable generation unit 13.

The actual time variable data D1 indicates, for each manufacturing ID, a value of temperature A and a value of pressure B, which are taken out from time 0 (t=0) to time 232 (t=232: last time).

Since the number of records of the actual time variable data D1 is data in one row for each manufacturing ID and a variable of [the number of time-series variables such as the temperature A×the number of times] is generated, the actual time variable data D1 is often considerably horizontally long data.

The actual time variable data D1 illustrated in FIG. 8 and the actual non-time-series data (in FIG. 4) are supplied to the predictor generation unit 11.

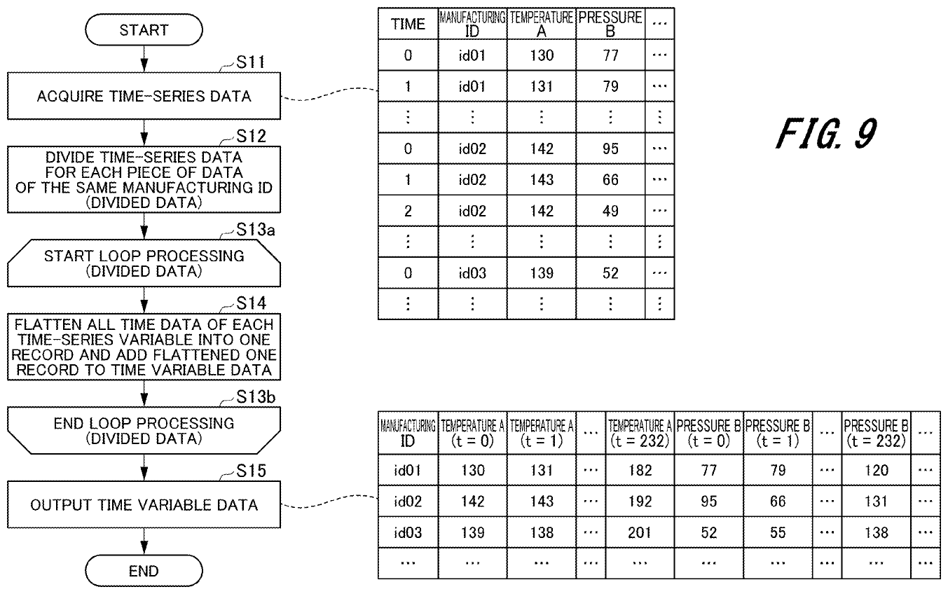

FIG. 9 is a flowchart illustrating a procedure of processing performed by the time variable generation unit 13.

First, the time variable generation unit 13 acquires the actual time-series data stored in the actual time-series data storage unit 21 (step S11). The actual time-series data herein is, for example, data such as the temperature A and the pressure B for each manufacturing ID, as illustrated in FIG. 3.

Then, the time variable generation unit 13 divides the acquired time-series data for each piece of data of the same manufacturing ID, thereby obtaining divided data (step S12).

Next, the time variable generation unit 13 starts loop processing of the divided data (step S13a). When the loop processing is started, the time variable generation unit 13 flattens all the time data of each time-series variable into one record and adds the one record to the time variable data (step S14). The time variable generation unit 13 ends the loop processing of the divided data (step S13b).

By repeating the loop start in step S13a and the loop end in step S13b by the number of pieces of data, the time variable generation unit 13 acquires the actual time variable data illustrated in FIG. 8.

Then, the time variable generation unit 13 outputs the acquired actual time variable data (step S15).

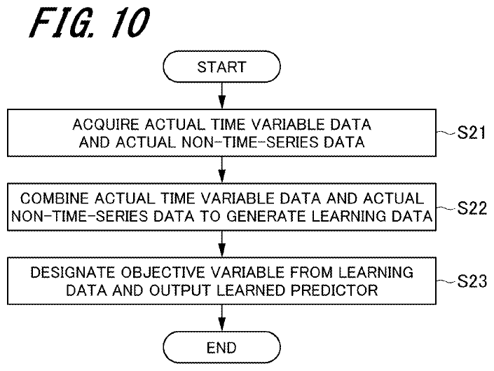

FIG. 10 is a flowchart illustrating a procedure of processing performed by the predictor generation unit 11.

The predictor generation unit 11 acquires the actual time variable data illustrated in FIG. 8 and the actual non-time-series data illustrated in FIG. 4 (step S21).

Then, the predictor generation unit 11 combines the acquired actual time variable data and the actual non-time-series data to generate learning data (step S22). Here, the actual time variable data has one row for each manufacturing ID, as illustrated in FIG. 8. Therefore, by using the actual time variable data as a key, learning data is generated by combining the actual non-time-series data and the manufacturing ID with this data, and learning processing is performed.

Then, an objective variable is designated from the learning data and the objective variable is learned, and the learned predictor 19 is output (step S23).

### [Processing of Time-Series Causal Model Generation Unit]

FIG. 11 is a diagram illustrating processing performed by the time-series causal model generation unit 12.

The lag variable generation unit 14 generates actual lag variable data D2 from the actual time-series data stored in the actual time-series data storage unit 21.

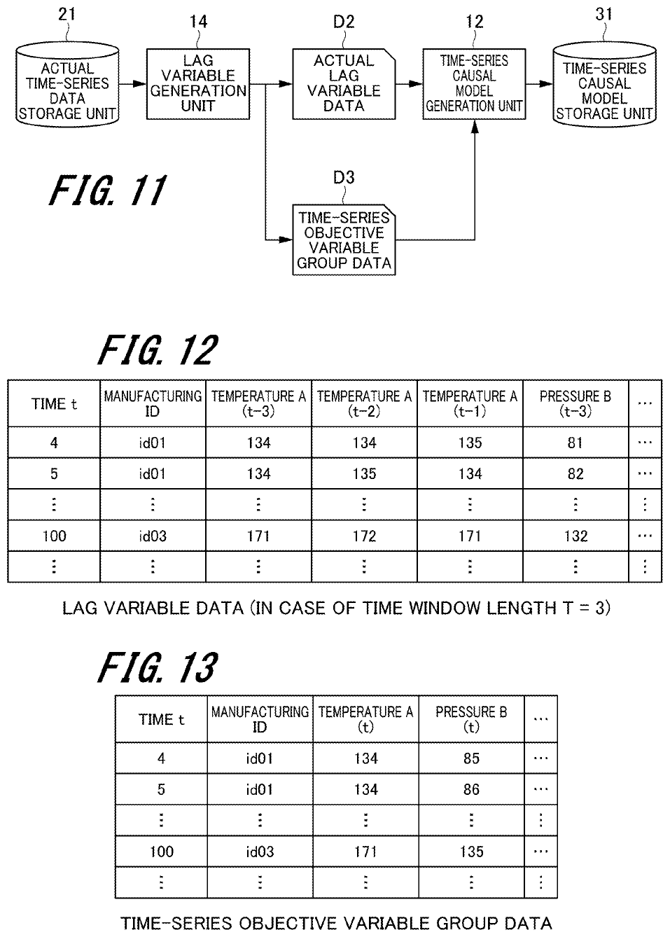

FIG. 12 illustrates an example of the actual lag variable data.

Here, as illustrated in FIG. 12, with a time window length T=3, data in the time period from 3 time before to 1 time before becomes each of the variables, and a lag variable with respect to time t (4, 5, . . . ) is obtained. That is, in the case of the time window length T=3, data at a minus time at which no data is present is required at time t=3 or less, and as such, the lag variable starts from t=4.

Referring back to the description in FIG. 11, the lag variable generation unit 14 generates time-series objective variable group data D3 from the actual time-series data.

FIG. 13 illustrates an example of the time-series objective variable group data D3 generated by the lag variable generation unit 14.

As illustrated in FIG. 13, the time-series objective variable group data D3 is a value of each time-series variable at time t (each time after t=4). For example, the time-series objective variable group data D3 includes values such as the temperature A and the pressure B of the manufacturing ID=id01 at time t=4.

The time-series causal model generation unit 12 generates a time-series causal model from the actual lag variable data D2 and the time-series objective variable group data D3, and the generated time-series causal model is stored in the time-series causal model storage unit 31. Processing of storing the generated time-series causal model in the time-series causal model storage unit 31 is referred to as time-series causal model storage processing.

The time-series model is a model generated by the number of time-series variables, and the value of each variable at a certain time t is predicted from the values of all variables in the time period immediately before t. Although a description has been given as to an example in which the time period from which the prediction is performed is determined by allowing a user to designate the time window length T on the screen, the prediction may be automatically determined for each time-series variable based on the prediction accuracy of the time-series causal model learned by variously changing the time window length T.

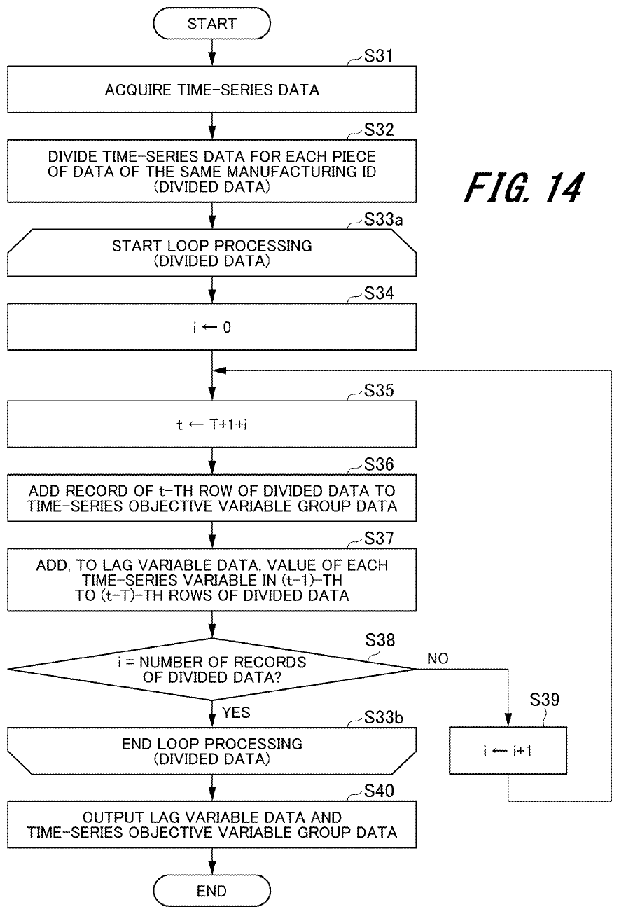

FIG. 14 is a flowchart illustrating a procedure of processing performed by the lag variable generation unit 14.

The lag variable generation unit 14 acquires time-series data (step S31). Then, the lag variable generation unit 14 divides the acquired time-series data for each piece of data of the same manufacturing ID (step S32).

Then, the lag variable generation unit 14 starts loop processing (step S33a).

When the loop processing is started, the lag variable generation unit 14 sets i to 0 (step S34) and sets (T+1+i) to t (step S35).

Then, the lag variable generation unit 14 adds a record in the t-th row of the divided data to the time-series objective variable group data (step S36). Further, the lag variable generation unit 14 adds, to the lag variable data, the value of each time-series variable in the (t−1)-th to the (t−T)-th rows of the divided data (step S37).

Thereafter, the lag variable generation unit 14 determines whether a current value of i is the number of records of the divided data (step S38). In step S38, when the value of i is not the number of records of the divided data (NO in step S38), the lag variable generation unit 14 adds one to the value of i (step S39), and returns to the processing in step S35.

When it is determined in step S38 that the value of i is the number of records of the divided data (YES in step S38), the loop processing from step S33a ends (step S33b).

Then, the lag variable generation unit 14 outputs the lag variable data and the time-series objective variable group data (step S40).

### [Processing of Contribution Degree Calculation Unit]

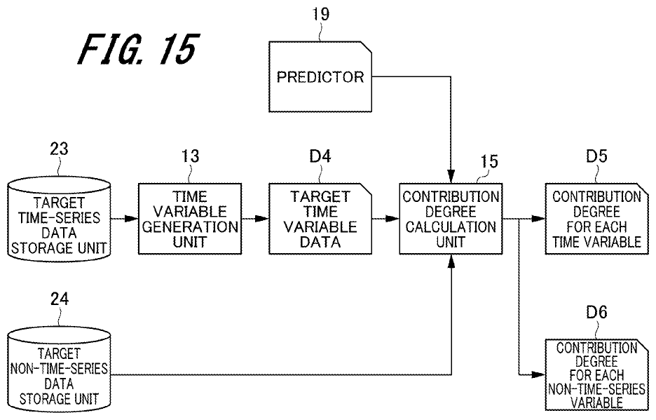

FIG. 15 is a diagram illustrating processing performed by the contribution degree calculation unit 15.

The time variable generation unit 13 obtains target time variable data D4 from the target time-series data stored in the target time-series data storage unit 23. The contribution degree calculation unit 15 performs contribution degree calculation processing of calculating a contribution degree of each input variable with respect to the output of the predictor 19. The contribution degree is obtained by dividing the contribution degree into two kinds of a contribution degree for each time variable D5 and a contribution degree for each non-time-series variable D6.

For example, in a case where there are two input variables X1 and X2, if the contribution degree of X1 is +150 and the contribution degree of X2 is −50, the sum is 100 of the output value of the predictor 19.

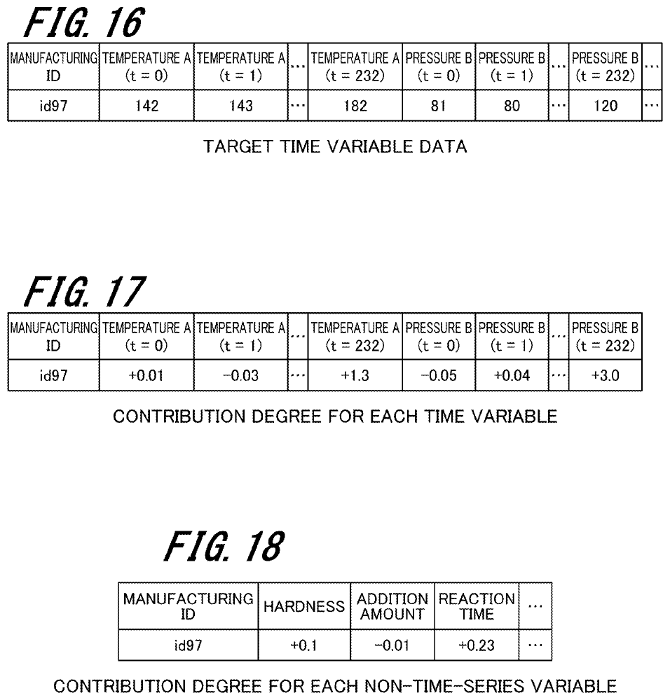

FIG. 16 illustrates an example of target time variable data.

The target time variable data is obtained by converting the target time-series data into a time variable which is an input format to the predictor.

For example, as illustrated in FIG. 16, data obtained by converting temperature A, pressure B, and the like of a certain manufacturing ID (id97) into data (time variable) from time 0 (t=0) to time 232 (t=232) is acquired as the target time variable data.

FIG. 17 illustrates an example of a contribution degree for each time variable, which is one of the outputs of the contribution degree calculation unit 15.

The contribution degree for each time variable is a result of calculating a contribution degree with respect to the output of the predictor 19 for each variable of the target time variable data. For example, as illustrated in FIG. 17, a contribution degree is calculated for each time variable such as temperature A and pressure B at each time. For example, +0.01 is obtained as a contribution degree at time t=0 and −0.03 is obtained as a contribution degree at time t=1 for the temperature A of a certain manufacturing ID (id97).

FIG. 18 illustrates an example of a contribution degree for each non-time-series variable, which is one of the outputs of the contribution degree calculation unit 15.

The contribution degree for each non-time-series variable is a result of calculating a contribution degree with respect to the output of the predictor 19 for each variable except an objective variable of non-time-series variable data. For example, the contribution degree with respect to the output of the predictor 19 is calculated for each of the hardness, the addition amount, the reaction time, and the like excluding opacity as an objective variable of a certain manufacturing ID (id97).

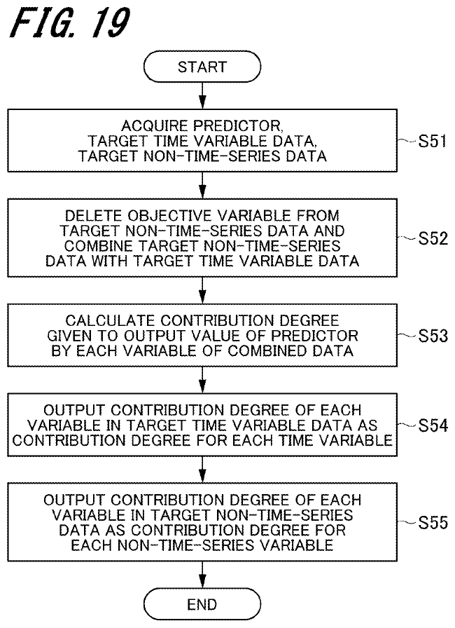

FIG. 19 is a flowchart illustrating a procedure of processing performed by the contribution degree calculation unit 15.

First, the contribution degree calculation unit 15 acquires an output of the predictor 19, target time variable data, and target non-time-series data (step S51). Then, the contribution degree calculation unit 15 deletes an objective variable from the acquired target non-time-series data. Thereafter, the target non-time-series data, the objective variable of which is deleted, is combined with the target time variable data (step S52).

Next, the contribution degree calculation unit 15 calculates a contribution degree given to the output value of the predictor 19 by each variable of the combined data (step S53).

Then, the contribution degree calculation unit 15 outputs the contribution degree of each variable in the target time variable data as the contribution degree for each time variable, as illustrated in FIG. 17 (step S54). Furthermore, as illustrated in FIG. 18, the contribution degree calculation unit 15 outputs the contribution degree of each variable in the target non-time-series data as a contribution degree for each non-time-series variable (step S55).

### [Restoration Processing of Contribution Degree for Each Time Variable]

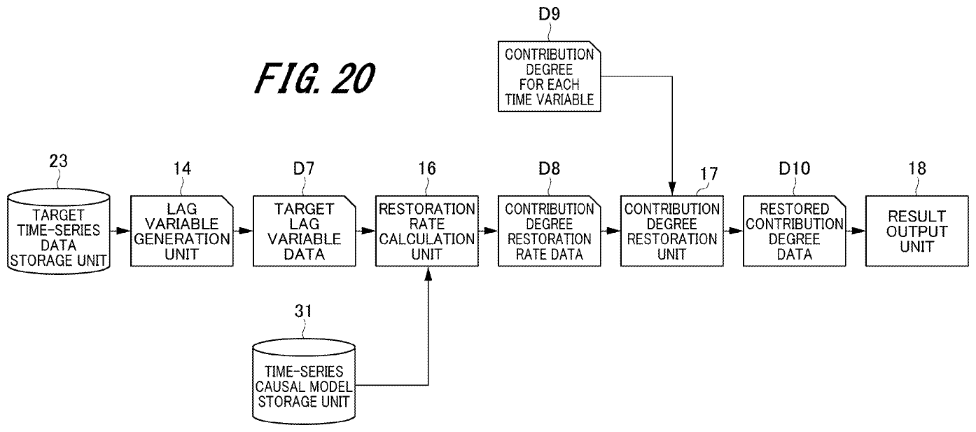

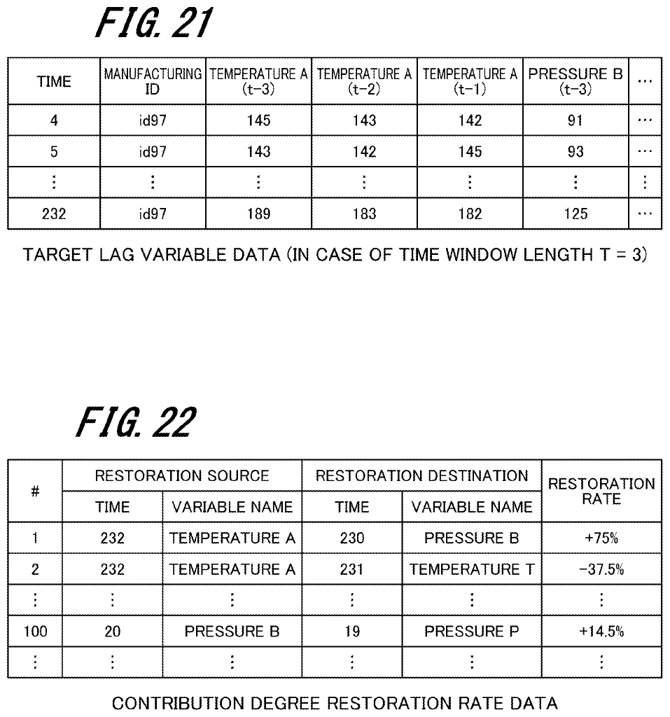

FIG. 20 is a diagram illustrating restoration processing of a contribution degree for each time variable. Processing illustrated in FIG. 20 performs processing of restoring a contribution degree Calculated for each time variable (time-series variable×time) to a root cause.

That is, as illustrated in FIG. 20, the restoration rate calculation unit 16 acquires target lag variable data D7 generated by the lag variable generation unit 14 and the time-series causal model stored in the time-series causal model storage unit 31. Then, the restoration rate calculation unit 16 calculates how much each contribution degree of a certain time variable, in other words, each contribution degree of a certain time-series variable at a certain time is restored, and obtains contribution degree restoration rate data D8.

Then, the contribution degree restoration unit 17 acquires the contribution degree restoration rate data D8 calculated by the restoration rate calculation unit 16 and a contribution degree for each time variable D9. The restoration rate calculation unit 16 performs processing of actually restoring a contribution degree based on a restoration rate to obtain restored contribution degree data D10.

The restored contribution degree data D10 obtained as described above is output from the result output unit 18.

FIG. 21 illustrates an example of target lag variable data, and FIG. 22 illustrates an example of contribution degree restoration rate data.

The target lag variable data illustrated in FIG. 21 is obtained by converting target time-series data into a lag variable.

For example, in the case of the time window length T=3, for the manufacturing ID=id97 at time t=4, data at t−3, data at t−2, and data at t−1 are obtained for temperature A, pressure B, and the like. Similarly, data is obtained until time t=5, t=6, . . . , and the last time t=232.

The contribution degree restoration rate data illustrated in FIG. 22 is data showing, by using a restoration rate, how much a contribution degree (a restoration source) of a certain variable at a certain time is restored to another certain variable (a restoration destination) at another certain time.

For example, restoration of the contribution degree of the temperature A (a restoration source) at time t=232 to the contribution degree of the pressure B (a restoration destination) at time t=230 at the restoration rate of +75% is shown as the contribution degree restoration rate data.

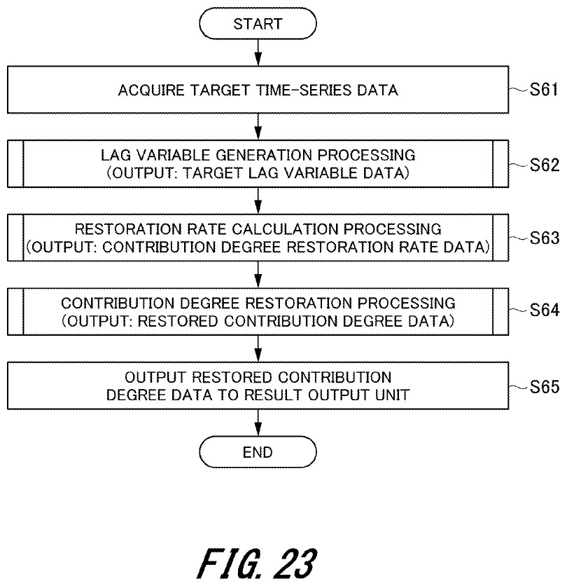

FIG. 23 is a flowchart illustrating a procedure of the restoration processing of the contribution degree for each time variable in FIG. 20.

First, the lag variable generation unit 14 acquires target time-series data (step S61).

Then, the lag variable generation unit 14 performs processing of generating a lag variable, and outputs target lag variable data (step S62). The target lag variable data is data as illustrated in FIG. 21.

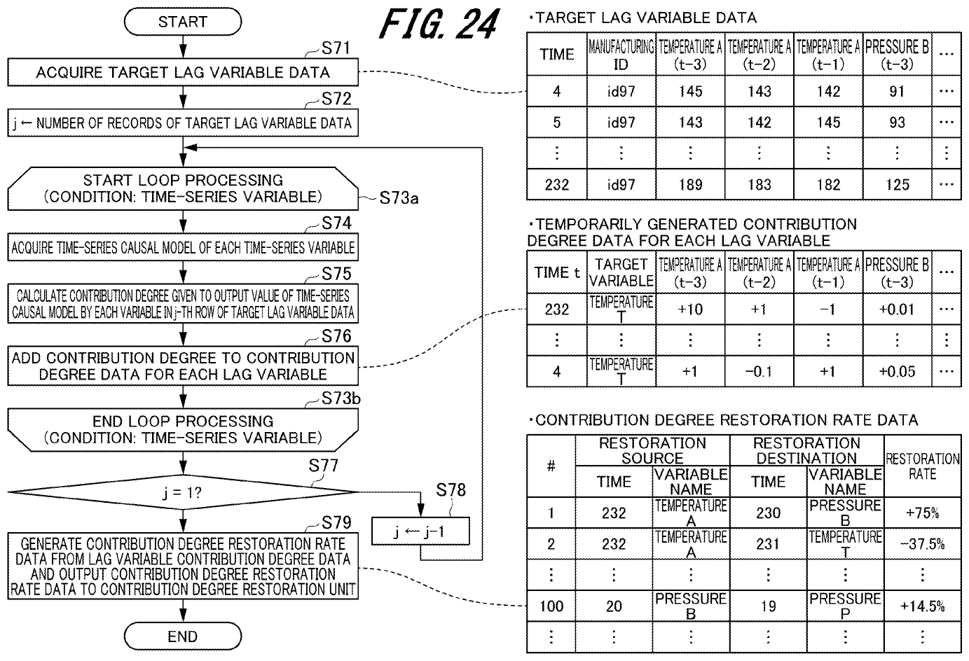

Next, the restoration rate calculation unit 16 performs restoration rate calculation processing from the target lag variable data generated by the lag variable generation unit 14 and the time-series causal model stored in the time-series causal model storage unit 31, and outputs contribution degree restoration rate data (step S63). Details of the restoration rate calculation processing in the restoration rate calculation unit 16 will be described with reference to FIG. 24.

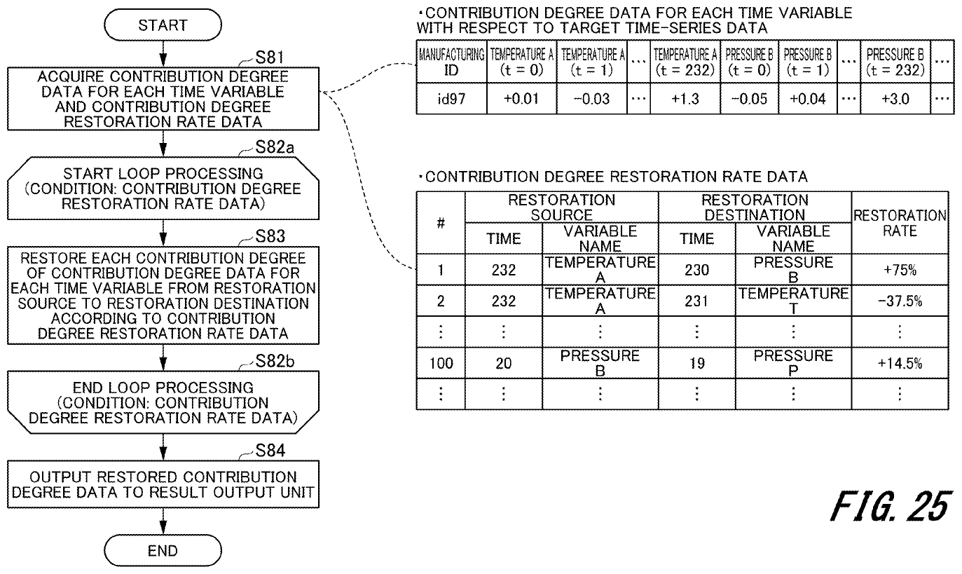

Then, the contribution degree restoration unit 17 performs contribution degree restoration processing based on the contribution degree restoration rate data calculated by the restoration rate calculation unit 16 and the contribution degree for each time variable, and outputs restored contribution degree data (step S64). Details of the contribution degree restoration processing in the restoration rate calculation unit 16 will be described with reference to FIG. 25.

Then, the restored contribution degree data obtained by the contribution degree restoration unit 17 is output from the result output unit 18 (step S65).

FIG. 24 is a flowchart illustrating a procedure of processing performed by the restoration rate calculation unit 16.

First, the restoration rate calculation unit 16 acquires target lag variable data (step S71). The target lag variable data is the data described with reference to FIG. 21.

The restoration rate calculation unit 16 acquiring the target lag variable data first sets the number of records of the target lag variable data to j (step S72). Thereafter, the restoration rate calculation unit 16 starts loop processing on the condition of a time-series variable (step S73a).

When the loop processing is started, the restoration rate calculation unit 16 acquires a time-series causal model of each time-series variable (step S74). Then, the restoration rate calculation unit 16 calculates a contribution degree given to an output value of the time-series causal model by each variable in the j-th row of the target lag variable data (step S75).

The restoration rate calculation unit 16 adds the calculated contribution degree to contribution degree data for each lag variable (step S76). Data obtained by adding the contribution degree to the contribution degree data for each lag variable is data as illustrated in the middle part on the right side of FIG. 24, and is a result of analyzing how much each lag variable contributes to a prediction value of each variable at each time by a predictor.

When the processing in steps S74 to S76 is performed, the loop processing using a time-series variable as a condition is completed (step S73b), and the restoration rate calculation unit 16 determines whether the value of j is “1” (step S77).

If the value of j is not “1” in step S77 (NO in step S77), the restoration rate calculation unit 16 subtracts one from the value of j (step S78), and returns to the loop processing in step S73a.

If the value of j is “1” in step S77 (YES in step S77), the restoration rate calculation unit 16 generates contribution degree restoration rate data from lag variable contribution degree data, and outputs the contribution degree restoration rate data to the contribution degree restoration unit 17 (step S79). The contribution degree restoration rate data is the data shown in FIG. 22.

FIG. 25 is a flowchart illustrating a procedure of processing performed by the contribution degree restoration unit 17.

First, the contribution degree restoration unit 17 acquires contribution degree data for each time variable with respect to the target time-series data and the contribution degree restoration rate data (step S81). The contribution degree data for each time variable with respect to the target time-series data is data, as shown in the upper right of FIG. 25, and the contribution degree restoration rate data is data, as shown in the lower right of FIG. 25.

Then, the contribution degree restoration unit 17 starts loop processing using the contribution degree restoration rate data as a condition (step S82a).

When the loop processing is started, the contribution degree restoration unit 17 restores each contribution degree of the contribution degree data for each time variable from a restoration source to a restoration destination according to the contribution degree restoration rate data (step S83). Then, the contribution degree restoration unit 17 ends the loop processing using the contribution degree restoration rate data as the condition (step S82b).

When the loop processing is completed, the contribution degree restoration unit 17 outputs the restored contribution degree data to the result output unit 18 (step S84).

### [Example of Factor Analysis Screen]

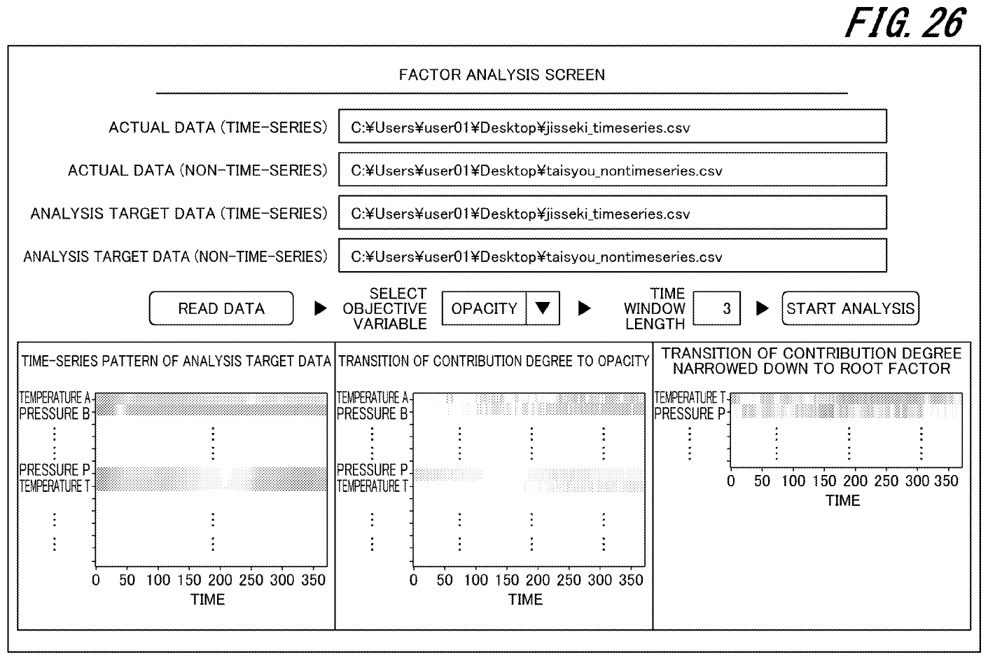

FIG. 26 illustrates an example of a factor analysis screen displayed on a display unit serving as the result output unit 18.

On the factor analysis screen illustrated in FIG. 26, various items are prepared thereon so as to select various pieces of data such as time-series actual data, non-time-series actual data, time-series analysis target data, and non-time-series analysis target data. In the example of FIG. 26, a user designates a storage location (folder) of each piece of data and instructs data of a factor analysis target.

In addition, a data reading button, a selection portion of an objective variable, a selection portion of a time window length, and an analysis start button are displayed on the factor analysis screen.

The data reading button is a button for receiving a reading start operation by a user of the instructed data of the factor analysis target.

The selection portion of the objective variable is a portion that receives selection by a user of an objective variable for obtaining a contribution degree. FIG. 26 illustrates an example in which “opacity” is selected as an objective variable.

The time window length is a portion for receiving selection by a user of the time window length T described with reference to FIG. 12 and the like.

The analysis start button is a button for receiving an analysis start operation.

Then, when the analysis start operation is performed, a factor analysis result is displayed, as illustrated in FIG. 26.

That is, as illustrated in the lower part of FIG. 26, the factor analysis screen displays a graph showing a time-series pattern of analysis target data, a graph showing the transition of a contribution degree to “opacity” which is an objective variable, and a graph showing the transition of a contribution degree narrowed down to a root factor.

The graph showing the time-series pattern of the analysis target data is obtained by visualizing target time variable data, and shows a temporal change in the target time variable data such as temperature A and pressure P.

The graph showing the transition of the contribution degree to “opacity”, which is the objective variable, is obtained by visualizing contribution degree data for each time-series variable that is not restored, and shows a temporal change in the contribution degree of the target time variable data such as the temperature A and the pressure P.

The graph showing the transition of the contribution degree narrowed down to the root factor is obtained by visualizing the restored contribution degree data for each time-series variable, and shows a temporal change in the contribution degree of the temperature A, the pressure P, and the like which are the root causes of “opacity”.

The factor analysis result is displayed as illustrated in FIG. 26, thereby making it possible to display the transition of a contribution degree narrowed down to a root cause of a change in “opacity”, which is a restored contribution degree. Therefore, by tracing back to the source, it is possible to present, to a user, causes such as a certain time point and a certain way of controlling a certain factor by restoring an influence of an intermediate factor to a root factor.

Accordingly, it is possible to present a contribution degree of a root cause at the time of factor analysis, unlike a case in which the influence of the intermediate factor that cannot be directly controlled is simply hidden.

In addition, it is possible to efficiently perform implementable countermeasure examination. Furthermore, even in a case where a specified root factor is a factor that cannot be controlled by a person, the specified root factor can also be utilized for countermeasure examination such as a design change.

It is noted that, the display of the transition of the contribution degree to opacity may be performed by simultaneously displaying a graph showing the transition of a contribution degree of a root cause, as illustrated in FIG. 26, and a graph showing the transition of the contribution degree, the graph being obtained by visualizing contribution degree data for each time-series variable that is not restored. As a result, it can be easily seen from the display that the corresponding root cause is really the cause. In this case, after the root cause is found, the subsequent examination can be performed appropriately by switching to the transition of the contribution degree narrowed down to the root cause.

### Second Embodiment

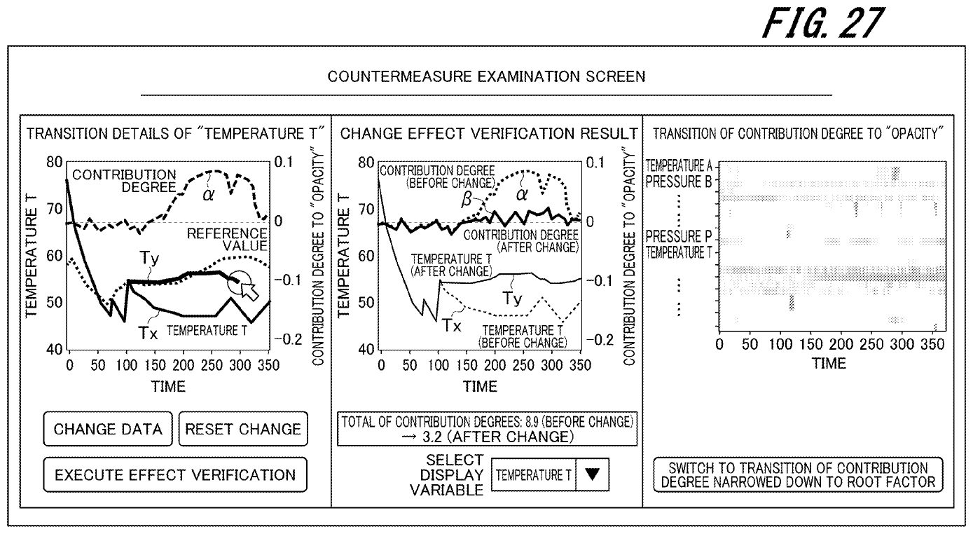

Next, a factor analysis support system for time-series data and a factor analysis support method for time-series data according to a second embodiment of the present invention will be described with reference to FIGS. 27 to 31.

In the second embodiment, the factor analysis support system described in the first embodiment is applied, and a countermeasure is examined based on a result obtained by the result output unit 18 of the factor analysis support system, and the effect is simulated. Factor analysis processing itself performed by the factor analysis support system is the same as the configuration and processing described with reference to FIGS. 1 to 26.

### [Example of Countermeasure Examination Screen]

FIG. 27 illustrates an example in which the result output unit 18 serving as a display unit displays a countermeasure examination screen.

The countermeasure examination screen illustrated in FIG. 27 displays a graph showing transition details of “temperature T”, a graph showing a change effect verification result, and a graph showing transition of a contribution degree to “opacity”.

The graph showing the transition details of the “temperature T” displays a characteristic Tx indicating a temporal change in the temperature T and a change in a contribution degree a. In the example of FIG. 27, the contribution degree a starts to increase after about 100 hours elapses.

In addition, the graph showing the transition details of the “temperature T” displays a reference value (a broken line) of the temperature T.

Further, a data change button, a change reset button, and an effect verification execution button are displayed in the vicinity of the graph showing the transition details of the “temperature T”.

Here, it is assumed that a data change is indicated by the data change button by the user's operation, and a change Ty (a thick line) after the change of the temperature T is indicated in a section where a contribution degree is high.

As a result, the effect after the change is displayed in the graph of the change effect verification result.

That is, the graph of the change effect verification result displays the characteristic Tx indicating the temporal change in the temperature T before the change and the change in the contribution degree a, and also displays a characteristic Ty indicating the temporal change in the temperature T after the change and a change in a contribution degree B.

In addition, a total value of a contribution degree and a selection field of a display variable are displayed in a display portion of the graph of the change effect verification result. FIG. 27 illustrates an example in which the “temperature T” is selected in the selection field of the display variable.

The factor analysis support system of the present embodiment generates time-series data reflecting a content (here, the temperature T) of Ty, the data of which is changed in the graph showing the transition details, calculates a contribution degree, and visualizes and displays a result of executing a predicted value of opacity or the like by a predictor.

In addition, as the graph showing the transition of the contribution degree to the “opacity”, the transition of the contribution degree to the “opacity” such as the temperature A and the pressure B is displayed. In the display portion of the graph showing the transition of the contribution degree, a button for switching to a contribution degree narrowed down to a root cause is displayed.

When a user operation is performed on the button for switching to the contribution degree narrowed down to the root cause, the graph showing the transition of the contribution degree is switched to a graph showing a result of restoring the contribution degree to the root cause of opacity.

### [Processing of Preliminary Effect Verification Reflecting Contents of Countermeasure Examination]

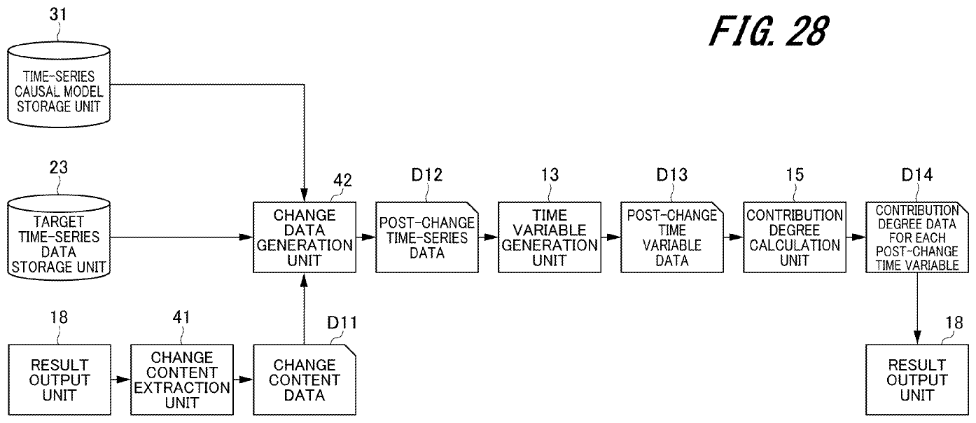

FIG. 28 is a diagram illustrating a configuration for the factor analysis support system for the time-series data to perform preliminary effect verification processing reflecting contents of countermeasure examination described in FIG. 27.

First, a change content extraction unit 41 extracts an operation accompanying the display in the result output unit 18 (an operation accompanying the display in FIG. 27), and obtains change content data D11.

The change content data D11 is supplied to a change data generation unit 42.

The change data generation unit 42 acquires a time-series causal model from the time-series causal model storage unit 31, and also acquires target time-series data from the target time-series data storage unit 23.

Then, the change data generation unit 42 generates post-change time-series data D12 based on the change content data D11, and supplies the generated post-change time-series data D12 to the time variable generation unit 13.

The time variable generation unit 13 generates post-change time variable data D13 and supplies the generated post-change time variable data D13 to the contribution degree calculation unit 15.

The contribution degree calculation unit 15 calculates a contribution degree with respect to the post-change time variable data D13, and obtains contribution degree data for each post-change time variable D14. The contribution degree data for each post-change time variable D14 is output by the result output unit 18.

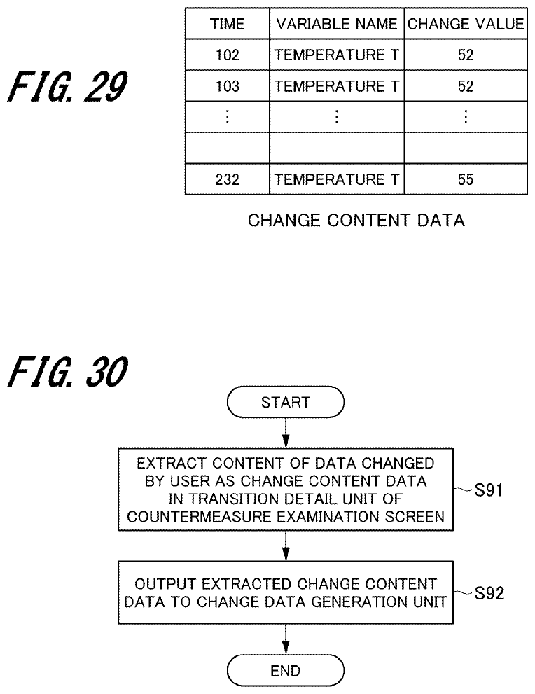

FIG. 29 illustrates an example of the change content data D11.

The change content data D11 is details of data in which a value of a range (time 102 to 232) designated by a user for a specific variable (here, the temperature T) is changed on the screen illustrated in FIG. 27.

FIG. 30 is a flowchart illustrating a processing procedure in the change content extraction unit 41.

The change content extraction unit 41 extracts a content of data changed by a user as change content data in the transition details portion of the countermeasure examination screen (the screen in FIG. 27) (step S91).

Next, the change content extraction unit 41 supplies the change content data extracted in step S91 to the change data generation unit 42 (step S92).

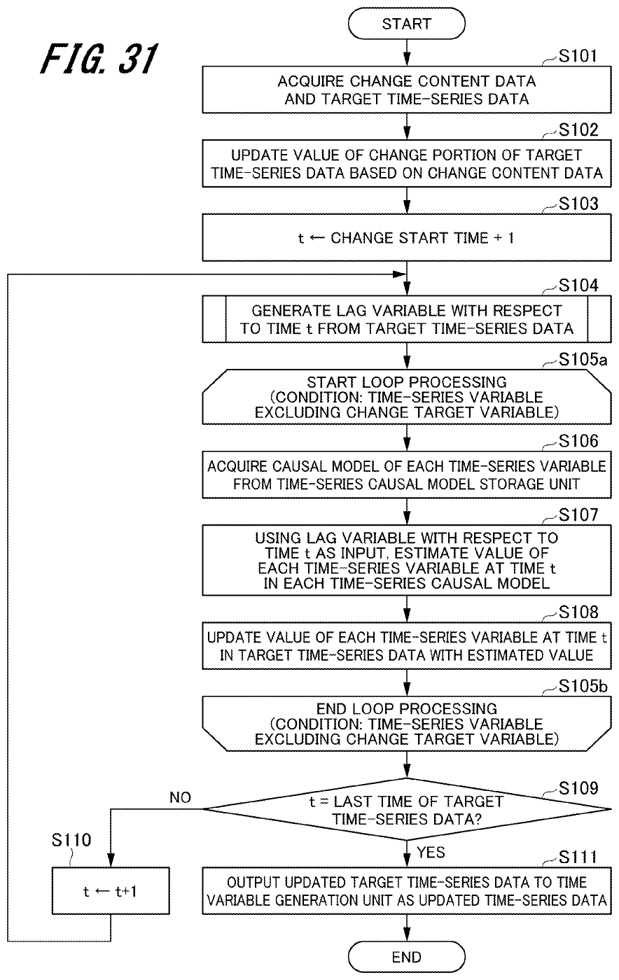

FIG. 31 is a flowchart illustrating a processing example of the change data generation unit 42.

The change data generation unit 42 estimates, based on the change content data, a value of another time-series variable that changes accordingly using the time-series causal model, and performs processing of generating target time-series data after change (post-change time-series data).

That is, the change data generation unit 42 first acquires the change content data and the target time-series data (step S101). Then, the change data generation unit 42 updates a change portion of the target time-series data based on the change content data (step S102).

Next, the change data generation unit 42 sets t to change start time+1 (step S103). Thereafter, the change data generation unit 42 generates a lag variable with respect to time t from the target time-series data (step S104). Then, the change data generation unit 42 starts loop processing using a time-series variable excluding a change target variable as a condition (step S105a).

When the loop processing is started, the change data generation unit 42 acquires a causal model of each time-series variable from the time-series causal model storage unit 31 (step S106).

Then, using a lag variable with respect to time t as an input, the change data generation unit 42 estimates a value of each time-series variable at time t in each time-series causal model (step S107). When acquiring an estimated value, the change data generation unit 42 updates the value of each time-series variable at time t in the target time-series data with the estimated value (step S108), and ends the loop processing (step S105b).

Thereafter, the change data generation unit 42 determines whether a value of current time t is the last time of the target time-series data (step S109). In step S109, when the value of current time t is not the last time of the target time-series data (NO in step S109), the change data generation unit 42 adds one to the value of time t and returns to the processing in step S104.

When the value of current time t is the last time of the target time-series data in step S109 (YES in step S109), the change data generation unit 42 outputs updated target time-series data to the time variable generation unit 13 as the post-change time-series data (step S111).

By performing the processing in this manner, it is possible to perform preliminary effect verification reflecting the contents of the countermeasure examination, as illustrated in FIG. 27. In addition, since the preliminary effect verification reflecting the contents of the countermeasure examination can be performed, a user can easily verify the effect of the proposed countermeasure in advance, and can find an appropriate countermeasure to the root cause.

That is, at the time of examining a countermeasure, it is possible to eliminate an influence of a factor that causes noise and then present a quality deterioration process by aggregating only factors that can be directly controlled by a person. Further, it is possible to significantly reduce factors that need to be interpreted at the time of examining a countermeasure, and it is possible to examine a countermeasure with factors that can be actually controlled.

### Modification

It is noted that the embodiments described so far have been described in detail in order to facilitate understanding of the present invention, and are not necessarily limited to those having all the described configurations. Furthermore, the configuration and processing described in each of the above-described embodiments can be variously modified and changed.

For example, in each of the above-described embodiments, a description has been given as to an example in which temperature or the like is controlled as a root cause for improving opacity in a manufacturing line, but the present invention may be applied to portions other than such a manufacturing line.

In addition, the factor analysis support system for the time-series data illustrated in FIG. 1 is configured by three computers 10, 20, and 30, but the configuration including three computers is one example, and is not limited to the configuration of FIG. 1.

In addition, as each computer, for example, a general-purpose computer may have a program mounted therein and configured to execute the processing described in each embodiment, thereby configuring a factor analysis support system for time-series data.

In this case, regarding the program mounted in the computer, the program may be transferred to the computer by being stored in a recording medium such as an external memory, an IC card, an SD card, or an optical disk.

In addition, in the configuration diagram illustrated in FIG. 1 and the like, only control lines and information lines considered to be necessary for description are illustrated, and all control lines and information lines on a product are not necessarily illustrated. In practice, it may be considered that almost all the configurations are connected to each other.

What is claimed is:

1. A factor analysis support system for time-series data that analyzes transition of a contribution degree to an objective variable by a time-series variable, the system comprising:
a time-series causal model storage unit configured to store a time-series causal model for each time-series variable;
a contribution degree calculation unit configured to calculate, using the time-series causal model stored in the time-series causal model storage unit and time-series data of an analysis target, a contribution degree restoration rate obtained by evaluating how much the contribution degree of each time-series variable at each time is required to be restored to the contribution degree of another time-series variable at another time;
a contribution degree restoration unit configured to restore, based on the contribution degree restoration rate calculated by the contribution degree calculation unit, the contribution degree of each time-series variable at each time to the contribution degree of the other time-series variable at the other time, and to calculate the transition of the contribution degree by a root factor with respect to the objective variable; and
an output unit configured to output the contribution degree by the root factor with respect to the objective variable, the contribution degree being calculated by the contribution degree restoration unit.

2. The factor analysis support system according to claim 1, wherein
the time-series causal model stored in the time-series causal model storage unit is a model obtained by generating actual lag variable data and time-series objective variable group data from actual time-series data, and predicting from a value of a variable between the generated actual lag variable data and the generated time-series objective variable group data for a specific time to a time before a predetermined time.

3. The factor analysis support system according to claim 2, further comprising
a predictor configured to learn a relationship between past actual time-series data and/or actual non-time-series data and a state to be analyzed, wherein
the contribution degree calculation unit is configured to calculate, using a result learned the predictor, the contribution degree restoration rate.

4. The factor analysis support system according to claim 3, wherein,
when the root factor is specified based on the contribution degree restored by the contribution degree restoration unit, a post-change contribution degree of content change data when the root factor is changed is calculated.

5. The factor analysis support system according to claim 4, wherein
the output unit is configured to display a countermeasure examination screen, and
the content change data is obtained by allowing a user to perform an operation of changing the root factor on the countermeasure examination screen.

6. The factor analysis support system according to claim 1, wherein
the output unit is configured to display a factor analysis screen, and
the factor analysis screen displays a graph showing a time-series pattern of analysis target data, the graph being obtained by visualizing the time-series variable, and a graph showing the transition of the contribution degree of the root factor, the graph being obtained by visualizing the restored contribution degree.

7. The factor analysis support system according to claim 6, wherein
the factor analysis screen displays a graph showing the transition of the contribution degree, the graph being obtained by visualizing contribution degree data for each time-series variable that is not restored.

8. A factor analysis support method for time-series data for allowing a computer to analyze transition of a contribution degree to an objective variable by a time-series variable, the method comprising:
time-series causal model storage processing of allowing the computer to store a time-series causal model for each time-series variable;
contribution degree calculation processing of allowing the computer to calculate, using the time-series causal model stored in the time-series causal model storage processing and time-series data of an analysis target, a contribution degree restoration rate obtained by evaluating how much the contribution degree of each time-series variable at each time is required to be restored to the contribution degree of another time-series variable at another time;
contribution degree restoration processing of allowing the computer to restore, based on the contribution degree restoration rate calculated by the contribution degree calculation processing, the contribution degree of each time-series variable at each time to the contribution degree of the other time-series variable at the other time, and to calculate the transition of the contribution degree by a root factor with respect to the objective variable; and
output processing of allowing the computer to output the contribution degree by the root factor with respect to the objective variable, the contribution degree being calculated by the contribution degree restoration processing.
